(19) United States
(12) Patent Application Publication
(10) Pub. No.: US 2007/0125974 A1
(43) Pub. Date: Jun. 7, 2007

(54) Electromagnetically driven valve

(75) Inventors: Yutaka Sugie, Nishikamo-gun (JP); Masahiko Asano, Toyota-shi (JP)

Correspondence Address: KENYON & KENYON LLP, 1500 K STREET N.W., SUITE 700, WASHINGTON, DC, 20005, US

(73) Assignee: Toyota Jidosha Kabushiki Kaisha

(21) Appl. No.: 11/593,096

(22) Filed: Nov. 6, 2006

(30) Foreign Application Priority Data
Dec. 2, 2005 (JP) 2005-349125

(51) Int. Cl. F16K 31/02

(52) U.S. Cl. 251/129.09; 251/129.2

(57) ABSTRACT

An electromagnetically driven valve includes: a valve, including a valve shaft, which reciprocates to and fro along a direction in which the valve shaft extends; a disk, which is a magnetic member, and which is connected to and drives the valve; a first electromagnet which attracts the disk and keeps it in a valve closed position; and a torsion bar, which is a first elastic member, and which applies, to the disk, a force to remove the disk from the first electromagnet. In this first electromagnet, when the disk has been attracted to the first electromagnet and is in the valve closed position, a magnetic gap is provided at least in a portion of at least one magnetic circuit constituted by the electromagnet core and the disk.

The disclosure of Japanese Patent Application No. 2005-349125 filed on Dec. 2, 2005 including the specification, drawings and abstract is incorporated herein by reference in its entirety.

### BACKGROUND OF THE INVENTION

1. Field of the Invention

The present invention relates to an electromagnetically driven valve, and in particular relates to an electromagnetically driven valve that is used as an intake valve or an exhaust valve of an internal combustion engine.

2. Description of the Related Art

In relation to electromagnetically driven valves for internal combustion engines, for example, a single-coil type electromagnetically driven valve is described in Japanese Laid-Open Patent Publication Heisei 11-101110. The reference describes a valve in which movable plates are provided on both sides of an electromagnet, and these movable plates are integrally formed with the valve.

In the described valve, in the neutral position, one or the other of the gaps between the electromagnet and the movable plates on both sides thereof is narrower. In the initial state in which no electrical current is flowing in the coil, the valve is in its neutral position. When an electrical current flows through the coil, one of the movable plates is attracted to the electromagnet, for which the gap between it and the electromagnet is the narrower. When the electrical current is temporarily interrupted, the valve is pushed in the opposite direction (for example from the fully closed state to the fully open state) by a valve spring, and, due to the force of its inertia, it moves past its neutral position. Then, when the electrical current again flows through the coil, due to the electromagnetic force, the movable plate on the opposite side is held.

Electromagnetically driven valves are commonly used in internal combustion engines. The required electromagnetic force to drive the valves is generated by driving a coil with a power supply voltage of, for example, around 42 volts. Investigations have recently been undertaken for reducing costs by simplifying the structure of the power supply system, due to the fact that current power supply voltages are being reduced down to about 14 volts.

When driving an electromagnetically driven valve with such a reduced voltage, it is necessary to improve the responsiveness of the electromagnet of the electromagnetically driven valve, because it is not possible to obtain as great an electrical current for attraction as desired, due to diminution of the current rising response.

### SUMMARY OF THE INVENTION

The present invention provides an electromagnetically driven valve with enhanced operational reliability.

An aspect of the present invention relates to an electromagnetically driven valve, that includes: a valve, including a valve shaft, which reciprocates to and fro along the axial direction of the valve shaft; a magnetic member that is connected to and drives the valve; a first electromagnet that attracts the magnetic member and keeps the valve open or closed, as appropriate; a first elastic member which applies, to the magnetic member, a force to remove the magnetic member from the first electromagnet. The first electromagnet includes a first coil and a first electromagnet core, and a magnetic gap is provided at least in a portion of at least one magnetic circuit constituted by the first electromagnet core and the magnetic member, when the magnetic member has been attracted to the first electromagnet and is in the predetermined position.

The first electromagnet and the magnetic member may have a mutually attracting surface structure in which, when the magnetic member has been attracted to the first electromagnet and is in the predetermined position, at least portions of the magnetic member and the first electromagnetic core are in a magnetically non-contacting state.

The first electromagnet may further include a spacer which covers at least a portion of the first electromagnet core, and which contacts the magnetic member when the magnetic member has been attracted to the first electromagnet and is in the predetermined position.

The spacer may be made from a non-magnetic material, and the magnetic gap may be a portion where the spacer is disposed.

Also, the spacer may be made from a magnetic material, and provided at a portion of the surface of the first electromagnet core where it contacts the magnetic member; and the magnetic gap may be a portion of the contacting surface of the first electromagnet core where the spacer is not provided.

Moreover, the magnetic gap may be formed by only a portion of the first electromagnet core contacting against the magnetic member, when the magnetic member has been attracted to the first electromagnet and is in the predetermined position.

Furthermore, the contacting surface of the first electromagnet core against the magnetic member, and the contacting surface of the magnetic member against the first electromagnet core, may not be mutually parallel when the magnetic member is in the predetermined position.

The predetermined position may be the valve closed position; and there may be further included a second electromagnet which attracts the magnetic member and keeps it in the valve open position, and a second elastic member which, by applying an elastic force to the valve shaft, applies to the magnetic member a force to remove the magnetic member from the second electromagnet.

The second electromagnet may include a second coil, which is wired to the first coil, and equal electrical currents may flow in the first coil and the second coil.

This electromagnetically driven valve may further include a control device which performs control so as, after reducing the electrical current flowing in the first and second coils towards zero [Translator recommends changing to “substantially zero” or “to a low value”. However, I propose deleting this entirely. Presumably, once the current drops below the amount needed to hold the magnetic member in position (i.e., against the force of the spring), the coils will no longer generate enough force to counterbalance the force of the springs. Thus, reduction from the “holding current” appears to be sufficient. As such, it does not appear necessary to state “to zero” after indicating that the current will be reduced.] from a holding current, which is a predetermined electrical current value necessary for attracting the magnetic member to the predetermined position, then to flow an attraction electrical current in the first and second coils, for attracting the magnetic member to the second electromagnet.

According to this invention, it is possible to implement an electromagnetically driven valve which operates reliably, even in the case of, for example, application to a low voltage power supply, or to a monocoil structure.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a figure schematically showing the structure of an electromagnetically driven valve according to an embodiment of the present invention;

FIG. 2 is a block diagram showing a structure related to the driving and control of this electromagnetically driven valve;

FIG. 3 is a waveform diagram for explanation of changes of the electric current flowing in certain coils;

FIG. 4 is a figure showing a first example of a structure for providing a magnetic gap G shown in FIG. 1;

FIG. 5 is a figure showing a second example of a structure for providing this magnetic gap G shown in FIG. 1; and

FIG. 6 is a figure showing a third example of a structure for providing this magnetic gap G shown in FIG. 1.

### DETAILED DESCRIPTION OF THE PREFERRED EMBODIMENTS

In the following, the present invention will be explained in detail with reference to the drawings. It should be understood that, in the figures, portions which are the same or which correspond to one another are designated by the same reference numerals.

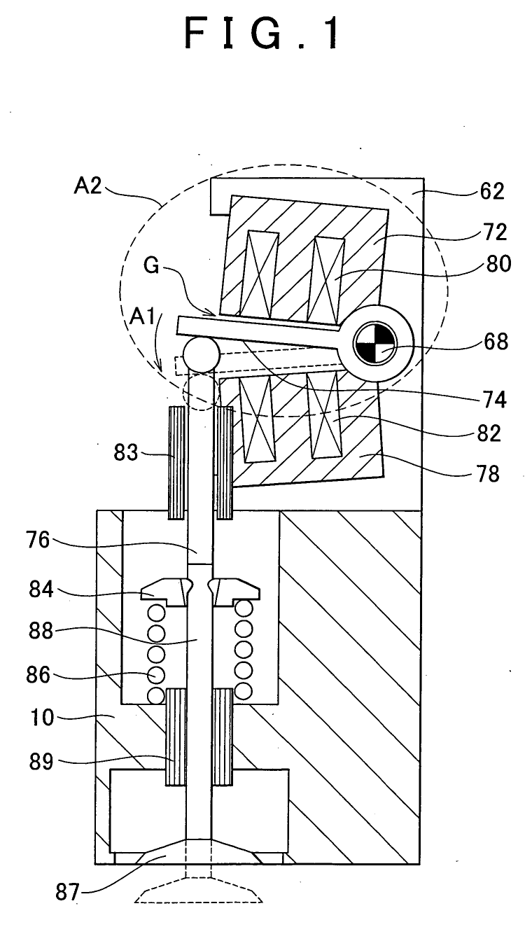

FIG. 1 is a figure schematically showing the structure of an electromagnetically driven valve according to an embodiment of the present invention. An engine, which is an internal combustion engine, includes a cylinder block, a cylinder head, pistons which reciprocate upwards and downwards within cylinders in the cylinder block, intake valves of an electromagnetic drive type which are provided to intake ports of each of the cylinders, and exhaust valves of an electromagnetic drive type which are provided to exhaust ports of each of the cylinders. For example, two each of the intake valves and the exhaust valves may be provided to each of the cylinders. In FIG. 1, a representative one of these electromagnetically driven valves is shown.

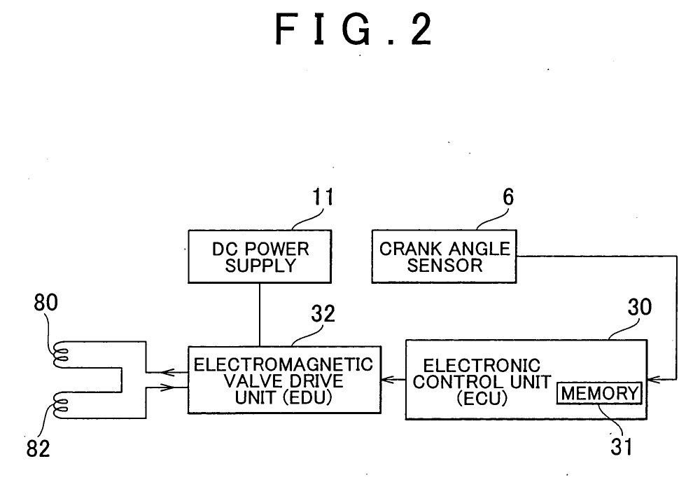

FIG. 2 is a block diagram showing a structure related to the driving and control of this electromagnetically driven valve. As shown in FIG. 2, a crank angle sensor 6 is fitted to this engine cylinder block, and detects the rotational speed of the engine. Various sensor outputs, such as the output of this crank angle sensor 6 and so on, are inputted to an electronic control unit (ECU) 30. The ECU 30, controls the injection timing and the injection amount of a fuel injection valve, the ignition timing of a spark plug, and also commands an electromagnetic drive unit (EDU) 32 to open an intake valve or an exhaust valve at a certain valve opening timing.

Power supply voltage is supplied to the EDU 32 from a DC power supply 11. Examples of such a DC power supply 11 may include an alternator which outputs a 14V power supply voltage, or a 12V battery or the like.

This electromagnetically driven valve includes: a valve 87, including a valve shaft 88, which reciprocates to and fro along the axial direction in which the valve shaft 88 extends; a disk 74, which is a magnetic member which is linked to and drives the valve 87; a first electromagnet which attracts the disk 74 to maintain the valve closed position; and a torsion bar 68, which is an elastic member which exerts a force on the disk 74, so as to remove that disk 74 away from the first electromagnet.

The first electromagnet, i.e. the electromagnet for closing the valve, includes a first coil 80 and a first electromagnet core 72. In this first electromagnet, when the disk 74 is attracted by the first electromagnet and the valve is closed, a magnetic gap G is provided in at least one of the magnetic circuits which are constituted by the first electromagnet core 72 and the disk 74, at least at a portion thereof.

The first electromagnet and the disk 74 are constructed with mutually attracting faces such that, when the disk 74 is attracted to the first electromagnet and the valve is closed, at least portions of the disk 74 and the first electromagnet core 72 are in a magnetically non-contacting state.

This electromagnetically driven valve further includes a second electromagnet which attracts the disk 74 and keeps the valve open, and a lower spring 86, which is a second elastic member which, by exerting its elastic force upon the valve shaft 88, exerts a force upon the disk 74 to move the magnetic member away from the second electromagnet. This second electromagnet, in other words the electromagnet for opening the valve, includes a second coil 82, which is wired to the first coil 80. Thus, the electrical currents which flow in the first coil 80 and the second coil 82 are equal to one another.

The electronic control unit (ECU) 30 of the electromagnetically driven valve, after the electrical current flowing in the first coil 80 and the second coil 82 has diminished towards zero from a holding current of a predetermined current value required for attracting the valve to its closed position, performs control so as to flow an attraction electrical current in the first coil 80 and the second coil 82, for attracting the disk 74 to the second electromagnet.

The disk 74 is a rocking member, one end of which is supported in a housing 62 so as to swivel freely. The other end of the disk 74 is provided with an operational portion that reciprocates the valve shaft to and fro along the direction in which the valve shaft extends.

The electronic control unit (ECU) 30 includes a memory 31. A power application pattern of the electromagnetically driven valve corresponding to the output of the crank angle sensor 6 is stored as a map in the memory 31.

The up and down movement of the valve 87 opens and closes an intake valve aperture or an exhaust valve aperture which is provided in the cylinder head 10. An intermediate stem 76 is provided at an upper portion of the valve shaft 88, and extends upwards from the valve 87. A cam follower pin is fixed at the upper end of this intermediate stem 76. This cam follower pin contacts the operational portion of the disk 74, on the opposite side of the end supported by the housing 62, which swivels freely to and fro. According to the rocking to and fro of the disk 74, the valve 87 reciprocates to and fro along the direction in which its valve shaft 88 extends.

A stroke ball bearing 89 is provided between the valve shaft 88 and the cylinder head 10, and thereby the valve shaft 88 is supported so as to be movable in the vertical direction. A retainer 84 is provided below the intermediate stem 76. The lower spring 86 is disposed around the valve shaft 88, between the retainer 84 and the cylinder head 10.

The electromagnetic actuator, which reciprocates the intermediate stem 76 to and fro, includes the aforementioned electromagnet for opening the valve and the aforementioned electromagnet for closing the valve, both fixed to the housing 62. The electromagnet for opening the valve includes an electromagnet core 78 for opening the valve, and the coil 82. The electromagnet for closing the valve includes an electromagnet core 72 for closing the valve, and the coil 80. The coil 80 and the coil 82 are wired so that they operate together, thus constituting a monocoil structure. It should be understood that it would also be acceptable not to form this monocoil structure, but rather to control the currents in the coil 80 and the coil 82 independently with the EDU 32. The disk 74 is alternately attracted by the electromagnet for opening the valve and the electromagnet for closing the valve.

Due to the elastic force of the torsion bar 68, which is an upper spring that works against the lower spring 86, the disk 74 exerts a force upon the intermediate stem 76 in the downward direction, in other words in the direction to open the valve. The other end of the disk 74 contacts the cam follower pin which is fixed to the upper end of the intermediate stem 76, so that it exerts a force in the downward direction upon the intermediate stem 76, in other words in the direction to open the valve.

Conversely, the lower spring 86 pushes upon the retainer 84 and exerts a force in the upward direction upon the intermediate stem 76, in other words in the direction to close the valve.

As the resultant force of the torsion bar 68 and the lower spring 86, when the valve 87 is fully closed, a force is generated in the direction to open it; while, conversely, when the valve 87 is fully open, a force is generated in the direction to close it. By taking advantage of the elastic force due to these springs when the distance between the disk 74 and the coil of the electromagnet which is attracting it is large, so that the electromagnetic force which attracts the disk 74 is weak, it is possible to reduce the size of the electromagnets.

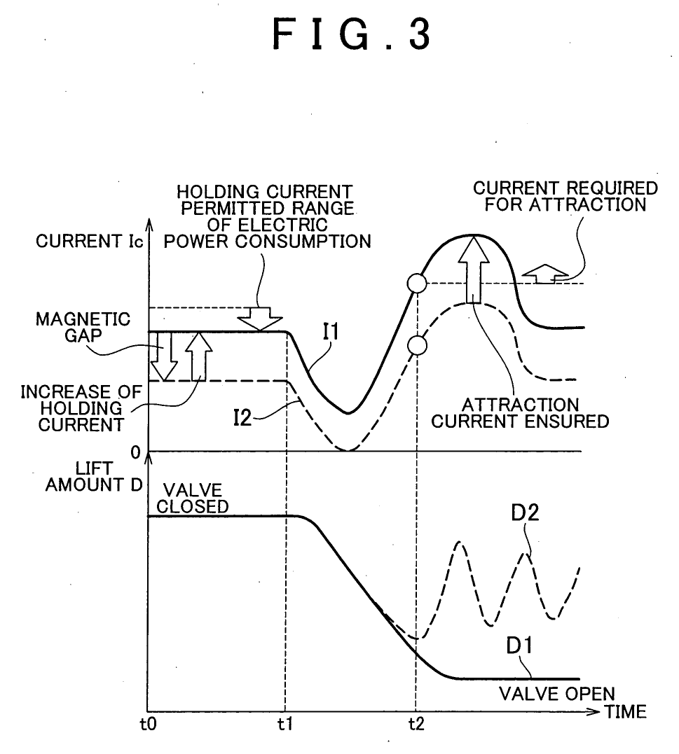

FIG. 3 is a waveform diagram for explanation of changes of the electric current flowing in the coils. In recent years, due to demands for the lowering of the power supply voltage for driving a coil, a situation has arisen in which it is difficult to obtain the desired electrical current for attraction, since the rise response of the current has decreased. First, with reference to FIGS. 1 and 3, the case will be explained in which, as shown for example by the current waveform 12, the holding current at the time points t0˜t1 is not very great, although it is sufficient for attracting the disk 74.

In this case if, between the time points t1˜t2, the coil current is temporarily decreased from the holding current towards zero in order to release the disk 74 from the attraction of the electromagnet on the valve closed side, and thereafter is again increased in order to attract the disk 74 with the electromagnet on the valve opening side, it sometimes happens that, at the time point t2, it is not possible to ensure the required electrical current for this attraction.

Because the coil has a certain inductance and the responsiveness of increase and decrease of the electrical current is poor when the voltage of the coil power supply is lowered, a certain slope is created in the increase and decrease waveforms of the current, and it is not possible either to reduce the electrical current in the coil directly to zero, or to increase it directly from zero to the current required for attraction. As a result, it is not possible to increase the coil electrical current up to the current required for attraction within the predetermined time period defined by the spring constants and so on. And also, as shown by the waveform D2, the lift amount due to the spring force undesirably vibrates in the vicinity of the neutral position, so that it is not possible to keep the valve 87 in the valve open state at the appropriate valve timing.

By contrast, in this embodiment of the present invention, in the valve closed state, the magnetic gap G shown in FIG. 1 is provided, and moreover, between the time points t0˜t1 shown in FIG. 3, as shown by the current waveform I1, in order to maintain the valve closed state just as it is, the holding current is increased within the permitted range for the electrical power consumption.

Although it may also be contemplated simply to increase the holding current, without providing the magnetic gap G, if this is done, an excessive magnetic flux is generated during the valve closed state, and the counter electromotive force when the electromagnet for closing the valve is turned OFF becomes large, so that the control becomes difficult.

By increasing the holding current while providing the magnetic gap G, along with suppressing excessive magnetic flux, it is also possible to ensure the required electrical current for attraction at the time point t2 and thereafter. Due to this, the valve opening operation in the direction shown by the arrow sign A1 in FIG. 1 can be reliably implemented.

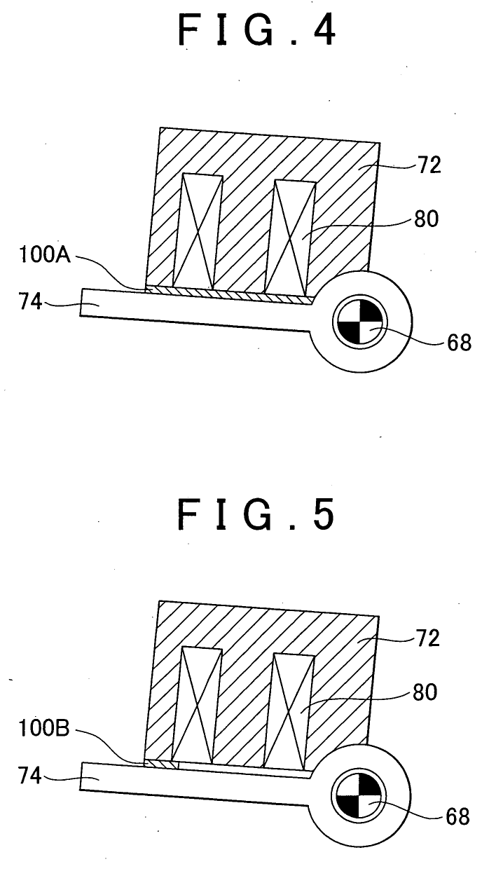

In the following, in figures that show in enlarged view the portion denoted in FIG. 1 by A2, a number of examples will be shown illustrating ways in which the magnetic gap G may be provided. FIG. 4 is a figure showing a first example of a structure for providing the magnetic gap G shown in FIG. 1.

In the example of a structure shown in FIG. 4, a spacer 100A is sandwiched between the disk 74 and the electromagnet core 72. The spacer 100A may be made from a non-magnetic material; however, any material may be suitable: for example, it may be stainless steel, resin, a paint or the like.

By making this spacer 100A from a non-magnetic material, the space occupied by the spacer 100A constitutes the magnetic gap G in FIG. 1.

In other words, the electromagnet for closing the valve includes the spacer 100A which covers at least a portion of the first electromagnet core 72, and which contacts the disk 74 when the disk 74 has been attracted by this electromagnet for closing the valve and the valve is thus in its closed position. The spacer 100A is made from a non-magnetic material, and the magnetic gap G is the space at which the spacer 100A is arranged.

It should be understood that this spacer 100A may be fixed to either one of the electromagnet core 72 and the disk 74.

FIG. 5 is a figure showing a second example of a structure for providing the magnetic gap G shown in FIG. 1. In the example of a structure shown in FIG. 5, a spacer 100B is sandwiched between the disk 74 and the electromagnet core 72. In other words, the electromagnet for closing the valve includes the spacer 100B which covers at least a portion of the first electromagnet core 72, and which contacts the disk 74 when the disk 74 has been attracted by this electromagnet for closing the valve and the valve is thus in its closed position.

The spacer 100B is made from a non-magnetic material, with the space where this spacer 100B is located corresponding to the magnetic gap G. Furthermore, by the spacer 100B being sandwiched, the layer of air which is present in the portion between the disk 74 and the electromagnet core 72 where it is not adhered also corresponds to the magnetic gap G. Although, in FIG. 5, the position of the spacer 100B is at the end edge of the disk 74, it would also be acceptable to vary this position, so as to provide the spacer 100B near the rotational axis of the disk 74.

The spacer 100B may also be a magnetic member which is provided at a portion of the contacting surface of the first electromagnet core 72 against the magnetic member; and, in this case, the magnetic gap G is the layer of air which is present at that portion of the contacting surface of the first electromagnet core 72 where the spacer 100B is not provided.

Moreover, it should be understood that this spacer 100B may be fixed to either one of the electromagnet core 72 and the disk 74.

Alternatively, instead of providing the spacer 100B, it would also be acceptable to make the portion of the spacer 100B in a shape at which the electromagnet core 72 projects. In this case, the spacer 100B would be made integrally with the electromagnet core 72, from the same magnetic material. Conversely, a protuberance may be provided on the side of the disk 74, corresponding to the spacer 100B.

Regardless of the form, the same beneficial effect may be obtained by reducing the contact area between the electromagnet core 72 and the disk 74, by providing a single minute protuberance on the contacting surface of one at least of the electromagnet core 72 and the disk 74, or a plurality thereof.

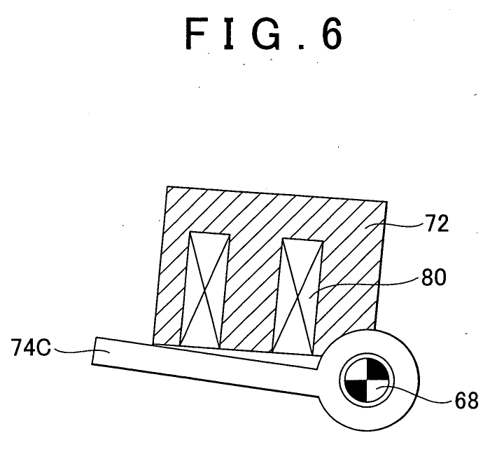

FIG. 6 is a figure showing a third example of a structure for providing the magnetic gap G shown in FIG. 1. In the example shown in FIG. 6, the magnetic gap G is formed by, when the disk 74 is in its predetermined position in which it has been attracted against the electromagnet for closing the valve, only a portion of the electromagnet core 72 contacting against the disk 74 (in FIG. 6, only against the end of the disk 74). In the example of FIG. 6, the contacting surface of the electromagnetic core 72 against the disk 74, and the contacting surface of the disk 74 against the electromagnetic core 72, are not parallel to one another when the disk is in the valve closed position.

In other words, this electromagnetic actuator is constructed so that the disk 74C and the electromagnet core 72 are inclined at different angles, with the disk 74C and the electromagnet core 72 thus only partially contacting one another. The magnetic gap G shown in FIG. 6 does not necessarily need to be uniform in the valve closed position.

As explained above, in this embodiment of the present invention, by providing the magnetic gap G between the electromagnet core and the disk, and by flowing a greater electrical current as a holding current than that flowed in an electromagnetically-driven valve without such a magnetic gap, it is possible to enhance the responsiveness of the current control even at low voltage, and thus to enhance the reliability of control.

It should be understood that although, in this embodiment, the provision of a magnetic gap G on the side of the electromagnet for closing the valve has been explained, it would also be possible to obtain the same beneficial effect, by providing a magnetic gap G on the side of the electromagnet for opening the valve, for the process of shifting the valve from the valve open position to the valve closed position, in the same manner.

Furthermore, the present invention is not limited to the case of a monocoil type or a rocking type electromagnetically driven valve; it could also be applied to a valve that is driven electromagnetically by another method. However, a particularly beneficial effect of the present invention may, be anticipated in the case of a monocoil type electromagnetically driven valve, in consideration of these points: (a) in the case of a monocoil type electromagnetically driven valve, it is not possible to control the electromagnet for opening the valve and the electromagnet for closing the valve independently; (b) in this case, the effective number of turns of the coil, which determines its inductance, is the sum of the number of turns of the coil of the electromagnet for opening the valve and the number of turns of the coil of the electromagnet for closing the valve; (c) even when the disk is being attracted by the electromagnet for opening the valve, it still experiences some influence of attractive force from the electromagnet for closing the valve; and the like.

The embodiment described above should not be considered as being limitative, since all its features have only been disclosed by way of example. The scope of the present invention is to be specified by the appended Claims, and not by any of the details of the above explanation; various changes in any embodiment of the present invention may be contemplated, provided that they are equivalent in meaning as far as the scope of the Claims is considered, and that they are within the range thereof.

What is claimed is:

1. An electromagnetically driven valve, comprising:
a valve, including a valve shaft, which reciprocates to and fro along in an axial direction of the valve shaft;
a magnetic member that is connected to and drives the valve;
a first electromagnet, which includes a first coil and a first electromagnet core, that attracts the magnetic member so as to keep the valve in a predetermined one of either a valve open position or a valve closed position; and
a first elastic member that applies a force to remove the magnetic member from the first electromagnet;
wherein:
a magnetic gap is provided at least in a portion of at least one magnetic circuit constituted by the first electromagnet core and the magnetic member, when the magnetic member has been attracted to the first electromagnet and is in the predetermined position.

2. The electromagnetically driven valve according to claim 1, wherein the first electromagnet and the magnetic member have a mutually attracting surface structure in which, when the magnetic member has been attracted to the first electromagnet and is in the predetermined position, at least a portion of the magnetic member and the first electromagnetic core are in a magnetically non-contacting state.

3. The electromagnetically driven valve according to claim 2, wherein the first electromagnet further includes a spacer that covers at least a portion of the first electromagnet core and that contacts the magnetic member when the magnetic member has been attracted to the first electromagnet and is in the predetermined position.

4. The electromagnetically driven valve according to claim 3, wherein the spacer is made from a non-magnetic material, and the magnetic gap is a portion where the spacer is disposed.

5. The electromagnetically driven valve according to claim 3, wherein the spacer is made from a magnetic material, and is provided on a portion of the surface of the first electromagnet core where it contacts the magnetic member; and the magnetic gap is a space above a portion of the contacting surface of the first electromagnet core where the spacer is not provided.

6. The electromagnetically driven valve according to claim 2, wherein the magnetic gap is formed by only a portion of the first electromagnet core contacting against the magnetic member, when the magnetic member has been attracted to the first electromagnet and is in the predetermined position.

7. The electromagnetically driven valve according to claim 6, wherein the contacting surface of the first electromagnet core against the magnetic member, and the contacting surface of the magnetic member against the first electromagnet core, are not mutually parallel when the magnetic member is in the predetermined position.

8. The electromagnetically driven valve according to claim 1, wherein the predetermined position is the valve closed position, and further comprising a second electromagnet that attracts the magnetic member and keeps the valve in the valve open position, and a second elastic member which, by applying an elastic force to the valve shaft, applies to the magnetic member a force to remove the magnetic member from the second electromagnet.

9. The electromagnetically driven valve according to claim 8, wherein the second electromagnet further comprises a second coil which is wired to the first coil, and equal electrical currents flow in the first coil and the second coil.

10. The electromagnetically driven valve according to claim 9, further comprising a control device that performs control so as, after having reduced the electrical current flowing in the first and second coils towards zero from a holding current, which is a predetermined electrical current value necessary for attracting the magnetic member to the predetermined position, then to flow an attraction electrical current in the first and second coils, to attract the magnetic member to the second electromagnet.
